(19) United States
(12) Patent Application Publication
(10) Pub. No.: US 2005/0177356 A1
(43) Pub. Date: Aug. 11, 2005

(54) Circuit simulation method and circuit simulation apparatus

(75) Inventor: Hirokazu Yonezawa, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/979,226

(22) Filed: Nov. 3, 2004

(30) Foreign Application Priority Data
Feb. 10, 2004 (JP) 2004-033996

(51) Int. Cl. G06F 17/50

(52) U.S. Cl. 703/14

(57) ABSTRACT

Variables corresponding to a plurality of fabrication variation components per parameter out of parameters included in input information are incorporated in accordance with a given model. Fabrication variation of the parameter is obtained by selectively giving fabrication variation information of respective fabrication variation components to the variables corresponding to the plurality of fabrication variation components by using the model, and input information influenced by the fabrication variation is output. In accordance with the output, circuit simulation is executed by referring to the input information influenced by the fabrication variation of the parameter.

### CROSS-REFERENCE TO RELATED APPLICATIONS

This application claims priority under 35 U.S.C. §119 on Patent Application No. 2004-033996 in Japan on Feb. 10, 2004, the entire contents of which are hereby incorporated by reference.

### BACKGROUND OF THE INVENTION

The present invention relates to technique for circuit simulation to be employed, in design of a system LSI or the like, for evaluating circuit characteristic variation derived from variation in fabrication process.

Recently, since transistors have been rapidly improved in the refinement and the degree of integration in accordance with the development of fabrication technique, it has become possible to provide semiconductor integrated circuits (hereinafter referred to as LSIs) including CMIS (Complementary Metal Insulator Semiconductor) devices with a variety of functions.

In the development of such LSIs, circuit simulation is generally employed. The circuit simulation is a technique to virtually reproduce the operation of a circuit on computer software and is widely employed in designing a circuit for the purpose of, for example, optimizing the circuit and checking the operation thereof. There are various methods for the circuit simulation, among which HSPICE manufactured by Synopsys, Inc., U.S.A. is known as typical circuit simulation software (hereinafter referred to as a circuit simulator).

Also, a design margin is generally provided in the circuit design. There are a variety of factors that affect circuit characteristics, and the design margin is allowance anticipated at the stage of design so that the circuit can be normally operated even when affected by these factors. The factors to be considered for the design margin are not only operational circumstances of the circuit such as a voltage and a temperature but also variation or fluctuation occurring in fabrication. The fabrication variation includes, for example, variation in process dimensions in lithography and material variation such as the degree of a dopant concentration. When such fabrication variation occurs, the characteristics of transistors and interconnects included in the circuit are also varied, resulting in varying the characteristics of the LSI including these elements. Since transistors have been rapidly developed to be refined recently, the influence of the fabrication variation on the circuit characteristics of an LSI has become more and more serious.

Therefore, a state of a circuit influenced by such fabrication variation is simulated by using the circuit simulator. The circuit simulation is performed, in the fabrication of an LSI, for designing the LSI that can be guaranteed for the normal operation of circuits even when given allowable fabrication variation occurs.

As a circuit simulation method performed in consideration of the fabrication variation, for example, the Monte Carlo analysis is known. Roughly speaking, the Monte Carlo analysis is an analysis method in which “random numbers generated for an input variable in accordance with a specific probability distribution are used for repeatedly performing general analysis with respect to the random numbers and resultant analyzed results are combined to obtain a probability distribution of an output variable”. Thus, a circuit designer can examine the operational range of the circuit on the basis of the thus obtained probability distribution of the output variable.

Now, a conventional circuit simulation method performed in consideration of the fabrication variation based on the Monte Carlo analysis will be described. Herein, it is assumed that an arbitrary CMOS circuit is subjected to the Monte Carlo analysis and that the gate length L of a MIS transistor is varied owing to the fabrication variation. It is also assumed that the gate length L is varied in accordance with a normal distribution N[μL, σL²] having a mean value μL and a standard deviation σL.

FIGS. 13A through 13C are diagrams for showing the relationships between managed ranges of the gate length of a MIS transistor, the drain current thereof and signal propagation delay occurring in the circuit and their distributions obtained at the stage of fabrication. In FIGS. 13A through 13C, solid lines indicate the distributions, obtained at the stage of fabrication, of the gate length L, the drain current Id and the signal propagation delay Tpd occurring in the circuit, and broken lines indicate the managed ranges of the gate length L, the drain current Id and the signal propagation delay Tpd occurring in the circuit. In general, the circuit is designed so that ranges obtained as ±3σL, ±3σId and ±3σtpd of the distributions of the gate length L, the drain current Id and the signal propagation delay Tpd can respectively fall within these managed ranges.

A circuit simulator reads a circuit net list and a parameter as input information and executes the simulation. The circuit net list describes information of dimensions, element constants and connection relationships of respective elements included in active devices such as transistors and passive devices such as resistors and capacitors. The parameter describes information determined on the basis of fabrication process. The circuit net list and the parameter are specifically described in, for example, “Star Hspice Manual (release 2000.2, May 2000)” published by Avant! Corporation, U.S.A. Now, procedures of the circuit simulation performed by the circuit simulator will be described.

First, in a circuit net list in which the fabrication variation is not considered, namely, which is obtained before causing variation, a variable (a varied parameter) to be varied in consideration of the fabrication variation, namely, a variable to be desired to vary in the simulation, is selected. Next, the description of the selected varied parameter in the circuit net list is changed by adding a new variable corresponding to a variation component.

FIGS. 14A and 14B are diagrams for respectively showing exemplified descriptions of two MIS transistors included in a circuit net list obtained before causing the variation and exemplified descriptions included in a circuit net list in which a variation component deltaL is added for causing the variation by using the gate length as a varied parameter. Each line of FIG. 14A indicates parameters of a transistor, and specifically, an identifying symbol M, four terminals S (a source terminal), G (a gate terminal), D (a drain terminal) and B (a substrate terminal), the name of used parameter NMODEL, a specific value of the gate length L, and a specific value of the gate width W are successively described in this order. FIG. 14B shows the descriptions included in the circuit net list in which the variation component deltaL is added to the specific values shown in FIG. 14A by using the gate length as the varied parameter for causing the variation on the assumption of the distribution of the gate length L as shown in FIG. 13A. Apart from the addition, FIGS. 14A and 14B are the same.

Next, normal random numbers N[0, σL²] in accordance with the variation component distribution of the gate length L are generated. In this case, a mean value is set to 0 (zero) for superimposing the variation component of the gate length alone. Every time one random number is generated, the component deltaL of FIG. 14B is given, so as to determine the gate length L of each transistor. Then, on the basis of the circuit net list including the gate lengths varied with respect to the random numbers, the circuit simulator performs the simulation.

In the circuit simulation, a drain current distribution as shown in FIG. 13B is calculated in accordance with the gate length distribution, and furthermore, on the basis of the drain current distribution, for example, a signal propagation delay distribution occurring in the circuit as shown in FIG. 13C is obtained.

In this manner, the conventional circuit simulation using the Monte Carlo analysis is performed, for circuit design, on the basis of the Monte Carlo analysis in which one distribution is assumed for a varied parameter such as the gate length that is affected by the fabrication variation. In most cases, one distribution is assumed with respect to the distribution of the gate length or the like as the total fabrication variation indicating the managed range as shown in FIG. 13A.

Also, as a circuit simulation method in consideration of variation, a method disclosed in Patent Document 1 is known. In the method disclosed in Patent Document 1, variation is expressed as a formula and simulation is performed with parameters included in the formula varied.

Furthermore, as a circuit simulation method on the basis of the Monte Carlo analysis, a method disclosed in Patent Document 2 in which the number of times of performing simulation is reduced is known.

Patent Document 1, however, discloses few specific embodiments and does not describe how the variation is caused in the simulation. Also, the method disclosed in Patent Document 2 is merely a technique to reduce the number of times of simulation performed for simulating a specific variation distribution.

The total fabrication variation σₜₒₜₐₗ is divided into an intra-chip variation component σᵢₙ and an extra-chip variation component σₒᵤₜ as shown in the following Formula 1:

Formula 1:
σₜₒₜₐₗ=\sqrt{(σᵢₙ²+σₒᵤₜ²)}
The extra-chip variation component σₒᵤₜ corresponds to a component not varied but uniform within a chip and includes variation among lots, wafers and chips. The intra-chip variation component σᵢₙ corresponds to variation caused among transistors included in an LSI. Thus, these variation components are different in their behaviors.

In the conventional method, however, the simulation is performed by providing merely one distribution to one varied parameter. This will be understood as follows: FIGS. 15A and 15B are diagrams for respectively explaining variation on the assumption that each chip has the variation and on the assumption that the variation includes an intra-chip variation component and an extra-chip variation component. In each of FIGS. 15A and 15B, it is assumed that there are 1 through N LSI chips (hereinafter simply referred to as the chips).

As shown in FIG. 15A, when the conventional method is employed, the variation component deltaL of the gate length or the like is different among the chips alone. In other words, it is premised that variation components of the gate lengths of circuits in small units and various transistors included in each chip are all the same within the chip. Actually, in former times when transistors and the like were not much refined, the extra-chip variation component was dominant in the fabrication variation. Therefore, it could be assumed that the variation was uniform within a chip as in the conventional method, namely, the total fabrication variation could be approximated by the following Formula 2:

Formula 2:
σₜₒₜₐₗ≈σₒᵤₜ
In other words, it was sufficient to assume one distribution as a dimension of a gate electrode or the like.

However, in accordance with the recent development in the refinement of transistors, the intra-chip variation component has become to occupy a large proportion in the whole variation, and it is now difficult to assume variation of the dimension such as a gate length to be uniform within a chip. Specifically, as shown in FIG. 15B, different variation components, that is, the extra-chip variation component and the intra-chip variation component, are superimposed with respect to each unit circuit or transistor included in the chip.

Furthermore, in the case of signal propagation delay of a circuit, the design margin for the fabrication variation is obtained in consideration of a delay distribution resulting from the circuit simulation. Each circuit included in an LSI can be generally decomposed into a large number of signal paths. In each signal path, a signal is transferred through a large number of stages of transistors, and therefore, when the characteristics of these transistors are varied, the delay characteristic between the input and the output of the signal path is also varied. In such a case, the influence on the delay is different between a case where the transistors are uniformly varied and a case where the transistors are individually varied. However, when one distribution is used for the simulation as in the conventional method, the transistors are uniformly varied, but there actually is an intra-chip variation component. Therefore, it is difficult to accurately determine the design margin by the conventional method.

Patent Document 1: Japanese Laid-Open Patent Publication No. 2002-318829 (Abstract)

Patent Document 2: Japanese Laid-Open Patent Publication No. 2003-6263 (Abstract)

### SUMMARY OF THE INVENTION

An object of the invention is providing a circuit simulation method or a circuit simulation apparatus in which circuit simulation carried out in designing an LSI can be simultaneously influenced by a plurality of fabrication variation components different in their behaviors and a design margin can be realistically determined.

In the circuit simulation method of this invention, fabrication variation of a plurality of fabrication variation components is calculated by incorporating variables corresponding to the plurality of fabrication variation components per parameter in accordance with a given model, and circuit simulation is executed by referring to input information influenced by the fabrication variation.

In this method, the circuit simulation can be executed with a plurality of fabrication variation components having different behaviors superimposed, and hence, more realistic circuit design can be carried out.

In one aspect, the fabrication variation components may include at least an extra-chip variation component and an intra-chip variation component.

Also, a plurality of random numbers may be generated in calculating the fabrication variation, and a plurality of correlated random numbers may be generated.

Alternatively, when signal path delay variation evaluation for obtaining a design margin is performed on the basis of the result of the circuit simulation after executing the circuit simulation, a design margin can be determined in consideration of the fabrication variation.

In this case, a derating factor is preferably used as the design margin.

In the case where the circuit includes a plurality of signal paths, a signal propagation delay difference among the plurality of signal paths may be obtained.

The circuit simulation apparatus of this invention includes means for incorporating, in accordance with a given model, variables corresponding to a plurality of fabrication variation components per parameter, means for calculating fabrication variation of the plural parameters, and means for executing circuit simulation by referring to input information influenced by the fabrication variation.

Thus, circuit simulation can be executed with a plurality of fabrication variation components having different behaviors superimposed, and hence, a circuit simulation apparatus for performing more realistic circuit design is provided.

The means for calculating the fabrication variation preferably includes means for generating random numbers.

Alternatively, the circuit simulation apparatus may further include means for setting a design margin on the basis of a result of the circuit simulation.

In this manner, according to the circuit simulation method or the circuit simulation apparatus of this invention, the circuit simulation can be executed with a plurality of fabrication variation components having different behaviors superimposed, and hence, a circuit can be designed or a design margin can be set more realistically.

Thus, the present invention is useful as a method or apparatus, employed in development of an LSI including CMOS devices or the like, for executing circuit simulation in which fabrication variation is taken into consideration.

### BRIEF DESCRIPTION OF THE DRAWINGS

FIG. 1 is a diagram of a circuit simulation apparatus according to Embodiment 1 of the invention in which fabrication variation is taken into consideration;

FIG. 2 is a circuit diagram for showing an exemplified CMOS circuit to which circuit simulation of Embodiment 1 is applied;

FIG. 3 is a diagram for showing a simulation method performed by the circuit simulation apparatus of Embodiment 1 in which fabrication variation is taken into consideration;

FIGS. 4A and 4B are diagrams for respectively showing exemplified descriptions of two circuits in a circuit net list obtained before causing variation and exemplified descriptions in a circuit net list to which two kinds of variation components are added with a gate length used as a varied parameter for causing the variation in Embodiment 1;

FIG. 5 is a flowchart for showing detailed procedures in a fabrication variation calculating step and a circuit simulation step of FIG. 3;

FIG. 6 is a table in which random number sets generated in Embodiment 1 and calculated fabrication variation are listed;

FIG. 7 is a diagram for showing exemplified descriptions in a circuit net list obtained by using random numbers;

FIGS. 8A and 8B are diagrams for respectively showing a case where a plurality of independent random numbers are generated and a case where correlated random numbers related to one another are generated;

FIG. 9 is a circuit simulation apparatus according to Embodiment 2 of the invention in which fabrication variation is taken into consideration;

FIG. 10 is a block circuit diagram for showing the configuration of a signal path circuit composed of inverter circuits used in Embodiment 2;

FIG. 11 is a graph in which variation of signal propagation delay is plotted along circuit cells on the signal path circuit in Embodiment 2;

FIG. 12 is a block circuit diagram for showing an example of a circuit used in Embodiment 3 of the invention;

FIGS. 13A, 13B and 13C are diagrams for showing the relationships between managed ranges of a gate length of a general MIS transistor, a drain current thereof and signal propagation delay occurring in the circuit, and their distributions obtained at the stage of fabrication;

FIGS. 14A and 14B are diagrams for respectively showing exemplified descriptions of two MIS transistors in a circuit net list obtained before causing variation and exemplified descriptions in a circuit net list to which a variation component deltaL is added with a gate length used as a varied parameter for causing the variation in a conventional method; and

FIGS. 15A and 15B are diagrams for generally explaining a case where an extra-chip variation component is caused among chips and a case where variation includes an intra-chip variation component and an extra-chip variation component, respectively.

### DETAILED DESCRIPTION OF THE INVENTION

### EMBODIMENT 1

Now, a circuit simulation apparatus according to Embodiment 1 of the invention in which fabrication variation is taken into consideration will be described with reference to the accompanying drawings. This embodiment describes circuit simulation means and procedures employed on the assumption that fabrication variation of a CMOS transistor, that is, a kind of CMIS transistors, is a varying factor of the circuit characteristic.

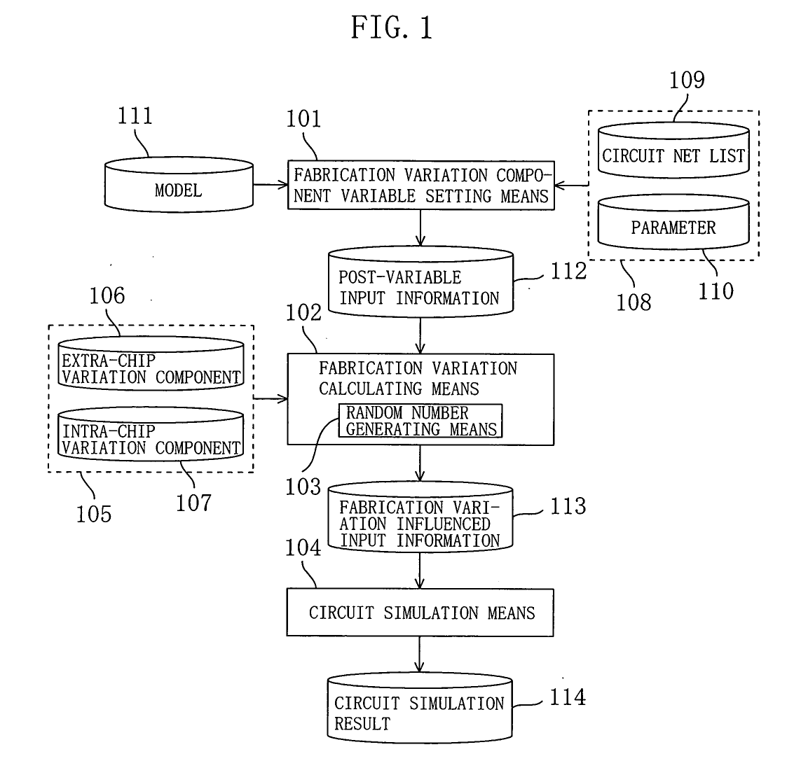

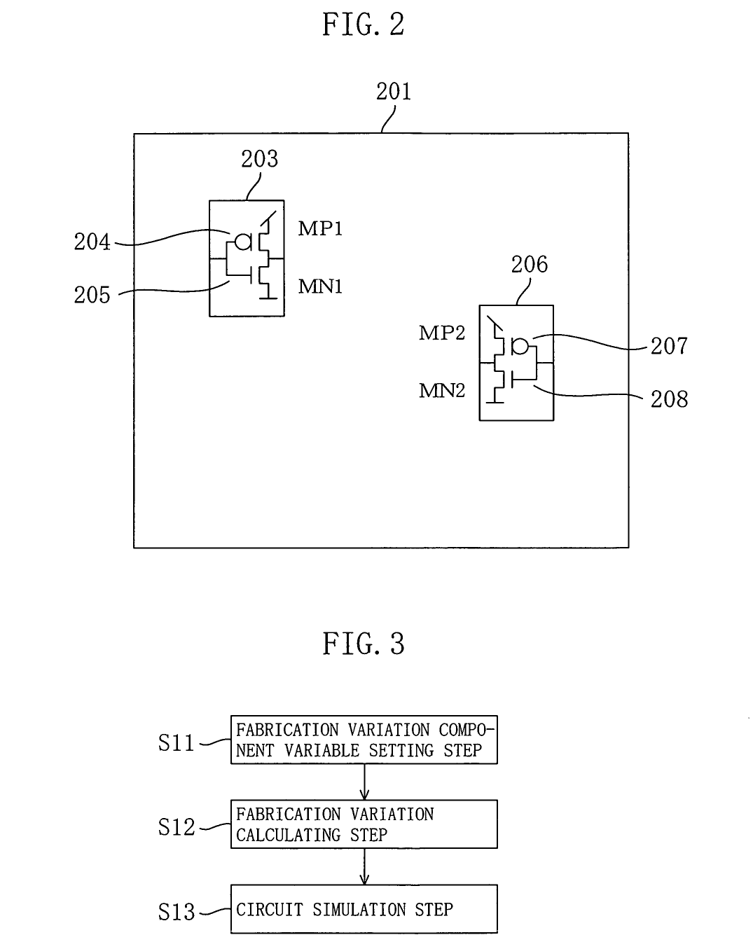

FIG. 1 is a diagram of the circuit simulation apparatus of Embodiment 1 in which fabrication variation is taken into consideration. FIG. 2 is a circuit diagram of an exemplified CMOS circuit to which circuit simulation of this embodiment is applied.

As shown in FIG. 1, the circuit simulation apparatus of this embodiment includes fabrication variation component variable setting means 101 for setting a fabrication variation component in the form of a variable; fabrication variation calculating means 102 for calculating fabrication variation on the basis of post-variable input information 112; and circuit simulation means 104 for performing the circuit simulation on the basis of fabrication variation influenced input information 113. Although the fabrication variation calculating means 102 includes random number generating means 103 in this embodiment, the random number generating means is not necessarily included therein.

The fabrication variation component variable setting means 101 reads a circuit net list 109 and a parameter 110 as input information 108 stored in a memory such as a cell library to be referred to in performing the circuit simulation and also reads a model 111 stored in a memory, and outputs the post-variable input information 112. Wherein, the parameter 110 may be a set of a plurality of parameters.

The fabrication variation calculating means 102 reads the post-variable input information 112 output from the fabrication variation component variable setting means 101 and fabrication variation information 105 that is stored in a memory and includes an extra-chip variation component 106 and an intra-chip variation component 107, and outputs the fabrication variation influenced input information 113.

The circuit simulation means 104 reads the fabrication variation influenced input information 113 output from the fabrication variation calculating means 102, performs the circuit simulation described later, and then outputs a circuit simulation result 114.

In this embodiment, the simulation performed for simulating variation of the gate lengths in a circuit shown in FIG. 2 caused due to the fabrication variation will be described. In FIG. 2, a reference numeral 201 denotes a chip, reference numerals 203 and 206 denote circuit cells, reference numerals 204 and 207 denote PMIS transistors respectively included in the circuit cells, and reference numerals 205 and 208 denote NMIS transistors respectively included in the circuit cells. It is herein assumed that the circuit cells 203 and 206 are CMIS circuits (inverters) composed of the same elements.

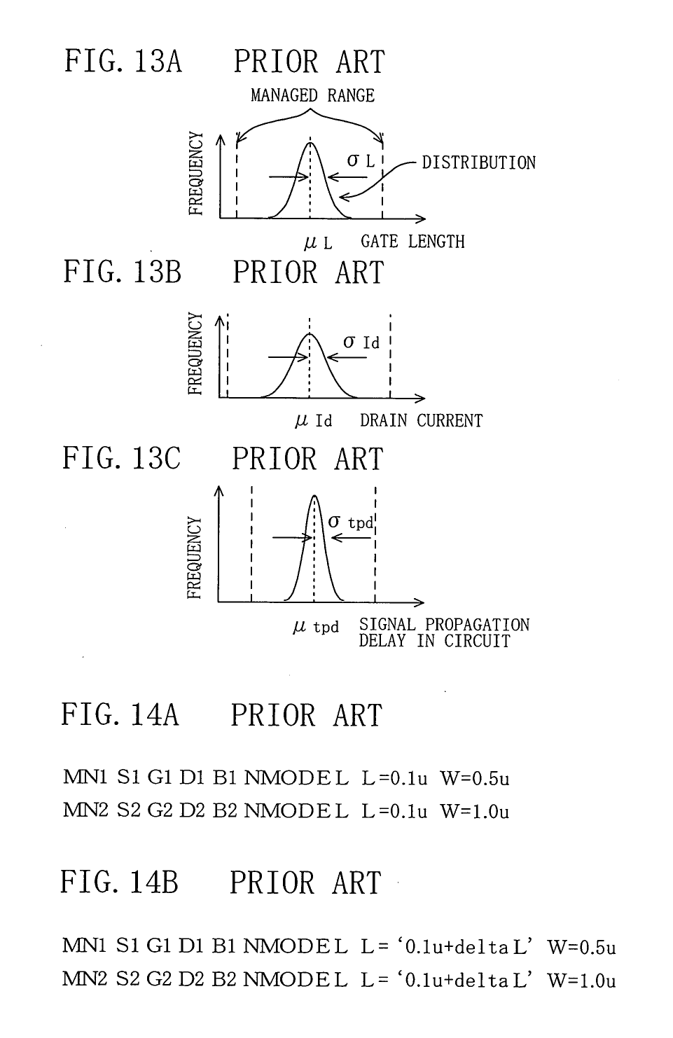

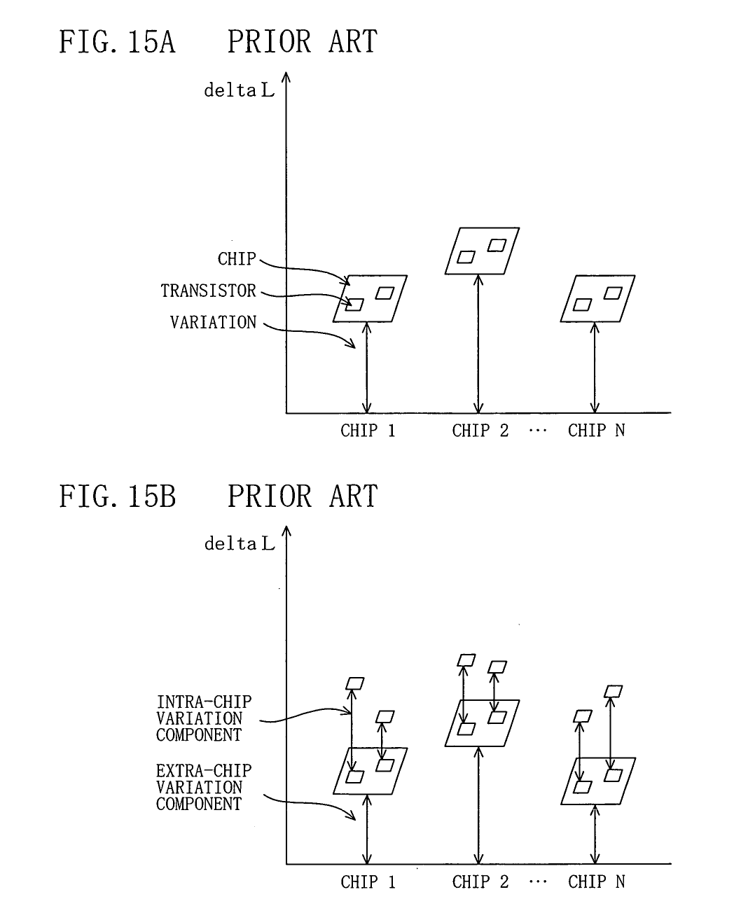

Also, it is assumed in this embodiment that the fabrication variation includes an intra-chip variation component σᵢₙ and an extra-chip variation component σₒᵤₜ. When both of these components are assumed to accord with a normal distribution, a standard deviation of the fabrication variation is expressed as the right-hand side of the aforementioned Formula 1. Total fabrication variation σₜₒₜₐₗ is expressed as a standard deviation of total fabrication variation, which corresponds to σL shown in FIG. 13A.

FIG. 3 shows a simulation method performed by the circuit simulation apparatus of Embodiment 1 in which the fabrication variation is taken into consideration. In FIG. 3, step S11 is a fabrication variation component variable setting step, step S12 is a fabrication variation calculating step, and step S13 is a circuit simulation step. Now, detailed procedures in the respective steps will be described.

Fabrication Variation Component Variable Setting Step

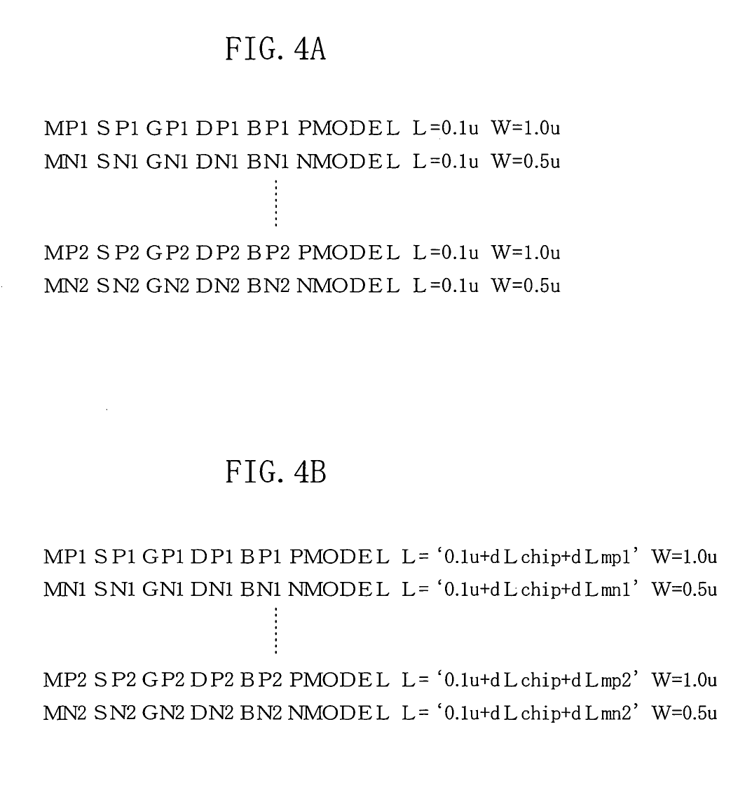

FIG. 4A shows exemplified descriptions of two circuits in a circuit net list obtained before causing variation, and FIG. 4B shows exemplified descriptions in a circuit net list to which two kinds of variation components are added by using a gate length as a varied parameter for causing the variation in this embodiment.

The circuit net list 109 obtained before taking the fabrication variation of the two circuit cells 203 and 206 of the chip 201 shown in FIG. 2 into consideration is described as shown in FIG. 4A. At this point, the gate length L has the same value, that is, 0.1 μm (expressed as “0.1μ” in FIG. 4A), in all the four transistors shown in FIG. 2.

The fabrication variation component variable setting means 101 first reads the circuit net list 109 and the parameter 110, that is, the input information 108. In this embodiment, the gate length L is used as a varied parameter to influence the circuit net list 109. Therefore, information of the parameter 110 is directly transferred to the post-variable input information 112 and the fabrication variation influenced input information 113 used in the subsequent procedures.

The fabrication variation component variable setting means 101 adds, to the gate length L, that is, the varied parameter, in the read circuit net list 109, the intra-chip variation component σᵢₙ and the extra-chip variation component σₒᵤₜ in the form of variables. At this point, the extra-chip variation component rout is set as the identical variable regardless of the transistors 204, 205, 207 and 208 included in the chip 201. Also, the intra-chip variation component σᵢₙ is set as different variables among these transistors. At this point, a formula to give the intra-chip variation component σᵢₙ and the extra-chip variation component σₒᵤₜ is determined by the fabrication variation component variable setting means 101 by referring to the model 111. In this embodiment, a model for expressing a sum of these components is used.

In the aforementioned processing performed by the fabrication variation component variable setting means 101, the circuit net list shown in FIG. 4A is changed as shown in FIG. 4B. As shown in FIG. 4B, the variables of the two kinds of variation components are introduced into each description of the gate length L so as to be expressed as a formula. In the formula, dLchip indicates the extra-chip variation component, and dLmp1, dLmn1, dLmp2 and dLmn2 respectively indicate the intra-chip variation components to be added to the transistors MP1, MN1, MP2 and MN2.

In this manner, the fabrication variation component variable setting means 101 performs processing for adding necessary variables to the circuit net list 109, so as to output the post-variable input information 112.

Fabrication Variation Calculating Step

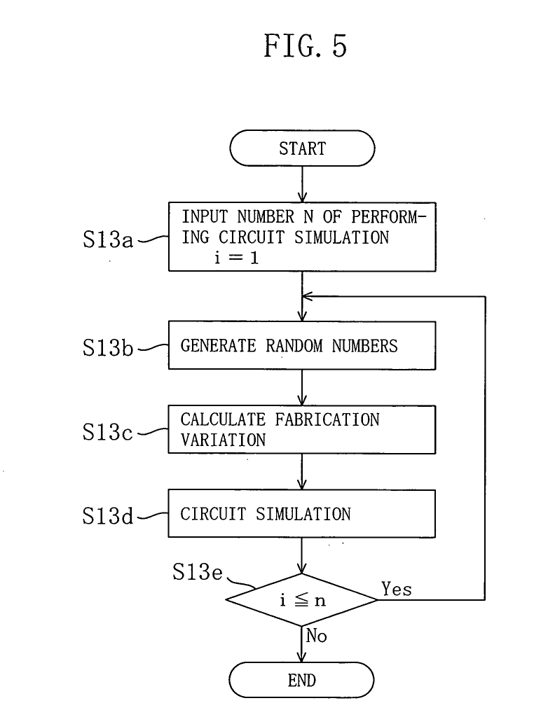

FIG. 5 is a flowchart for showing detailed procedures in the fabrication variation calculating step S12 and the circuit simulation step S13 of FIG. 3.

The fabrication variation calculating means 102 reads the post-variable input information 112 and the fabrication variation information 105. The fabrication variation information 105 includes the extra-chip variation component 106 and the intra-chip variation component 107. These components correspond to the two variables having been introduced to the varied parameter in the aforementioned manner. The extra-chip variation component 106 includes, as information necessary for reproducing a distribution of the extra-chip variation component of the gate length, for example, the standard deviation σₒᵤₜ shown in the aforementioned Formula 1. The intra-chip variation component 107 includes, as information necessary for reproducing a distribution of the intra-chip variation component of the gate length, for example, the standard deviation σᵢₙ shown in the aforementioned Formula 1.

The fabrication variation calculating means 102 includes the random number generating means 103, so as to generate random numbers with respect to the two components of the fabrication variation of the gate length (in step S13b of FIG. 5). Assuming that the circuit net list includes K transistors, (K+1) kinds of random numbers are generated as one set. In this embodiment, one kind of random number is generated for the extra-chip variation component, and K kinds of random numbers are generated for the intra-chip variation component. The shapes of distributions used for generating the random numbers are determined by referring to the extra-chip variation component 106 and the intra-chip variation component 107 of the fabrication variation information 105, so as to generate the random numbers in accordance with the shapes of their distributions. The random numbers for the K transistors have the same standard deviation. Distributions attained in this case are a normal distribution N[0, σₒᵤₜ²] with respect to the extra-chip variation component and a normal distribution N[0, σᵢₙ²] with respect to the intra-chip variation component. In these distributions, the mean value is set to 0 in order to superimpose variation components alone.

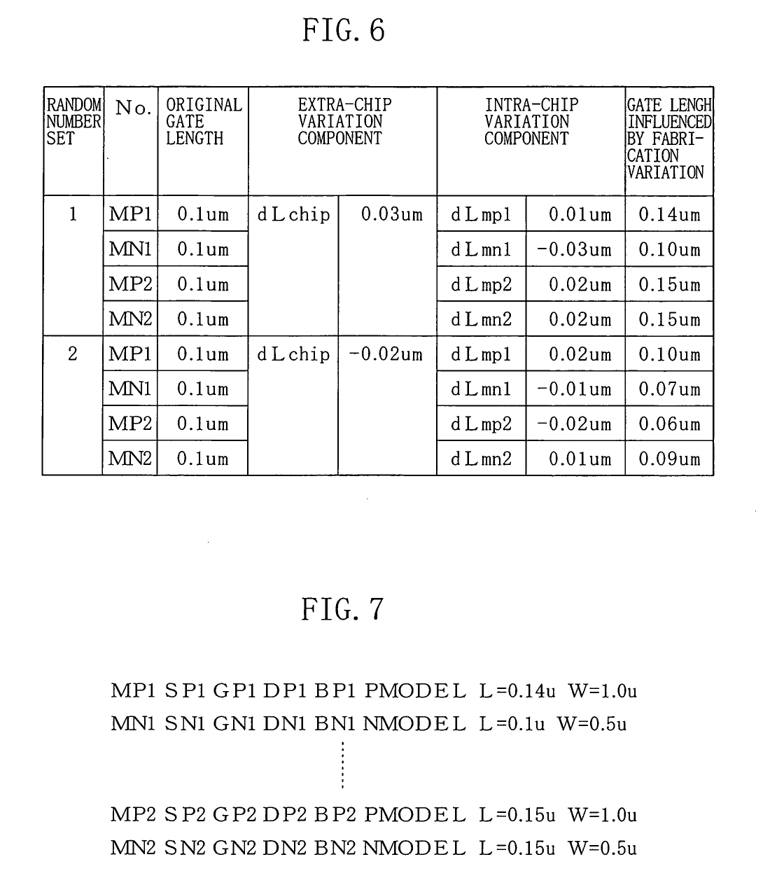

FIG. 6 is a table in which random number sets (the number of which is two in this embodiment) generated in this embodiment and calculated fabrication variation are listed. FIG. 7 shows examples of descriptions in the circuit net list obtained by using the random numbers.

In this manner, the fabrication variation calculating means 102 generates a plurality of random numbers, selectively provides the random numbers to the circuit net list to which the variables have been added, calculates the fabrication variation with respect to each set of random numbers (in step S13c of FIG. 5), and outputs the resultant as the fabrication variation influenced input information 113.

Circuit Simulation Step

After the number n of times of performing the circuit simulation is input (in step S13a), the circuit simulation means 104 reads the fabrication variation influenced input information 113, executes the circuit simulation with respect to each set of random numbers (in step S13d of FIG. 5), and after repeating the procedures of steps S13b through S13d until i becomes equal to n in step S13e, it outputs combined results of the simulation as the circuit simulation result 114.

At this point, the number of random numbers, namely, the number of samples, corresponds to the number of times of performing the circuit simulation, and the number n of times of performing the circuit simulation may be arbitrarily set in consideration of the accuracy of a desired distribution shape.

In this manner, according to this embodiment, a plurality of fabrication variation components having different behaviors are independently expressed to be selectively provided to respective components of the circuit net list. Therefore, the circuit simulation influenced by actual fabrication variation can be executed.

It is noted that this embodiment is merely an example of application of this invention and that the invention can be actually embodied in various manners. For example, although the gate length L alone is selected as a varied parameter in this embodiment, another variable may be selected as a varied parameter. Furthermore, the model 111 may be previously included in the fabrication variation component variable setting means 101. Alternatively, in the case where one model is always fixedly used, a formula corresponding to the model 111 need not be stored as separate data but the fabrication variation component variable setting means 101 is made to perform processing on the basis of the formula.

Also, although the fabrication variation is divided into the intra-chip variation component σᵢₙ and the extra-chip variation component σₒᵤₜ in this embodiment, the number of kinds of components can be increased if necessary. In this case, when the number of kinds of components is, for example, three, the description of the gate length in the circuit net list may be expressed by the following Formula 3:

Formula 3:
L=L_{typ}+Lₚₐᵣₐ₁+Lₚₐᵣₐ₂+Lₚₐᵣₐ₃
wherein L_{typ} indicates the gate length obtained before causing the variation (which is 0.1 μm in the case of FIGS. 4A and 4B).

Furthermore, although a normal distribution is assumed in this embodiment, an arbitrary distribution may be assumed. In this case, the fabrication variation information 105 includes information of the arbitrary distribution of each variation component.

Although the random number generating means 103 generates a plurality of independent random numbers in this embodiment, it may generate correlated random numbers related to one another.

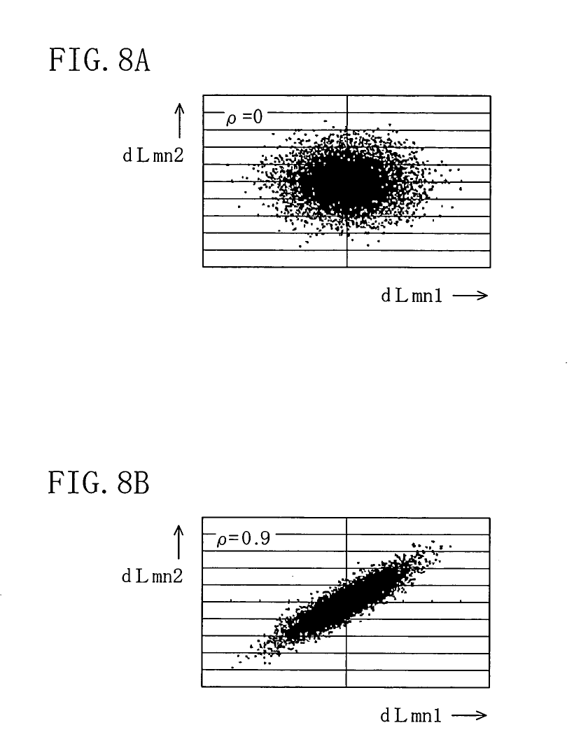

FIG. 8A shows an example where a plurality of independent random numbers are generated and FIG. 8B shows an example where correlated random numbers related to one another are generated.

The example shown in FIG. 8A corresponds to the method described in this embodiment, and with respect to correlation between, for example, variables dLmn1 and dLmn2, the correlation coefficient is zero (ρ=0). In the example shown in FIG. 8B, however, the random numbers are generated so that the correlation between the variables dLmn1 and dLmn2 may have a correlation coefficient (ρ=0.9). In this case, the fabrication variation information 105 previously includes correlation information such as a correlation coefficient between variation components so that the random number generating means 103 refers to its contents.

Although the original gate length is the same in all the transistors in this embodiment as shown in FIG. 6, the gate lengths of the respective transistors may have arbitrary values.

### EMBODIMENT 2

A circuit simulation apparatus according to Embodiment 2 of the invention in which fabrication variation is taken into consideration will now be described with reference to the accompanying drawings. Also in this embodiment, fabrication variation of CMIS transistors will be exemplified.

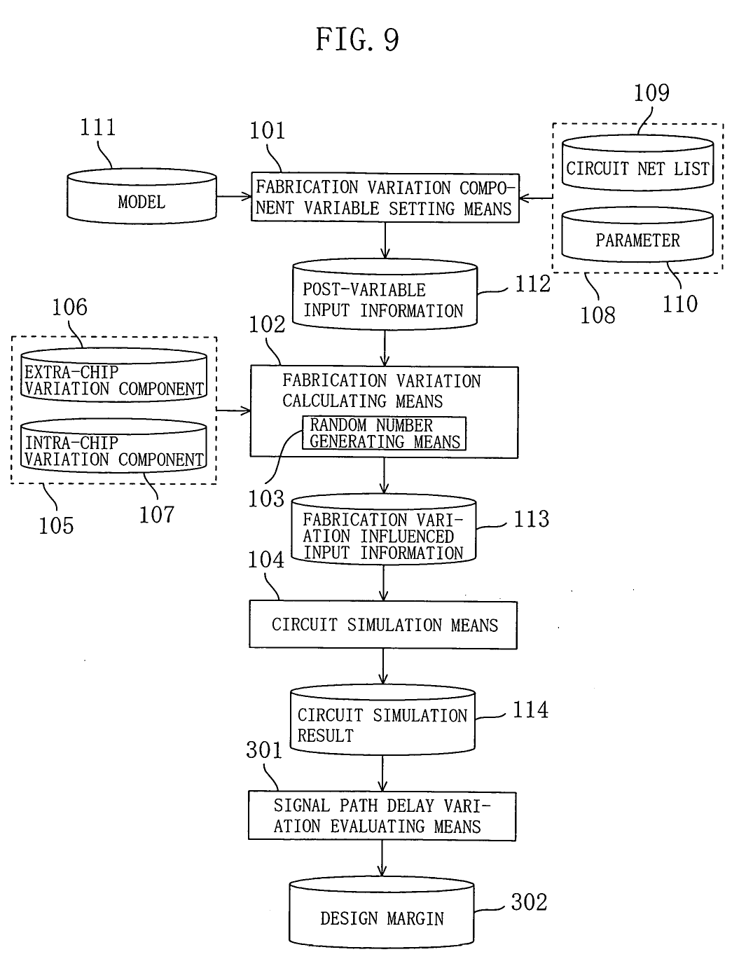

FIG. 9 is a diagram of the circuit simulation apparatus of Embodiment 2 in which the fabrication variation is taken into consideration. In FIG. 9, like reference numerals are used to refer to like elements shown in FIG. 1, and description of the operations of the elements shown in FIG. 1 is omitted.

The circuit simulation apparatus of this embodiment includes, differently from that of Embodiment 1, signal path delay variation evaluating means 301 for reading the circuit simulation result 114 and outputting a design margin 302.

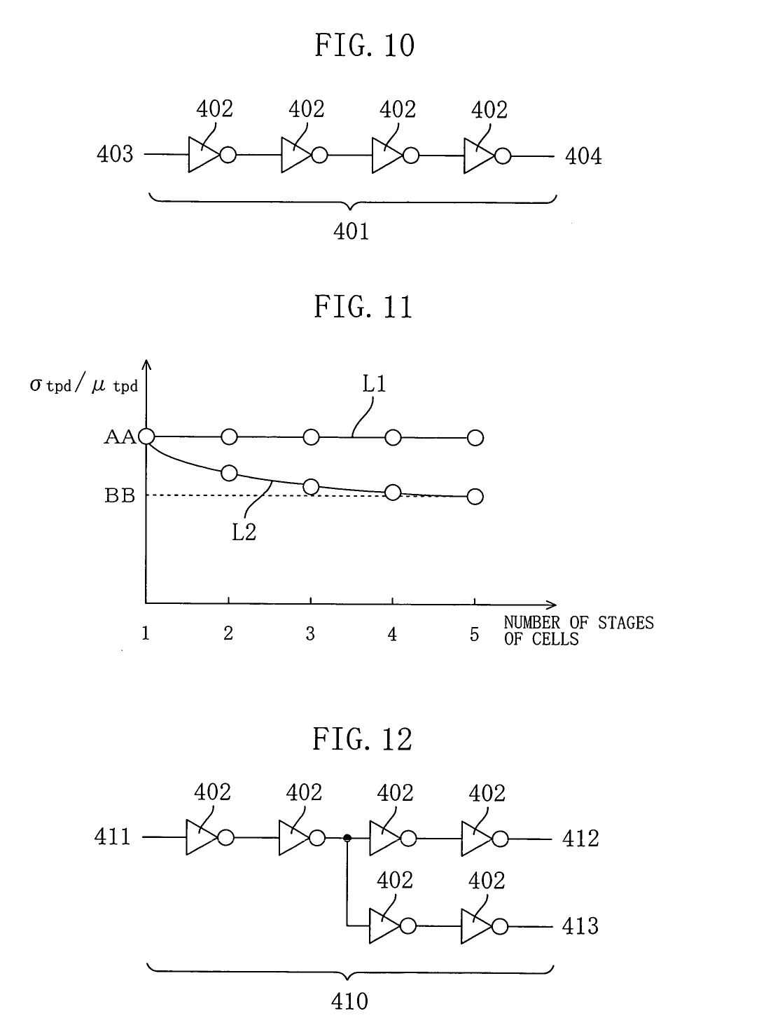

In the operation of the circuit simulation apparatus of this embodiment, differently from that of Embodiment 1, a signal path circuit 401 as shown in FIG. 10 is assumed as a circuit to be simulated. In the signal path circuit 401, one signal path is formed by serially connecting a plurality of circuit cells 402 to one another. Also, in the signal path circuit 401, the same circuit cells 402, all of which are inverter circuits, are connected in M stages (wherein, M is a natural number: M=4 in FIG. 10, for example), and the signal path circuit 401 is provided with an input port 403 and an output port 404.

As shown in FIG. 10, a signal path of a logic circuit included in a system LSI or the like can be generally decomposed into, for example, a signal path including M stages of circuit cells disposed between a pair of flip-flops. In this case, each circuit cell is generally composed of a logic circuit element such as an inverter, a NAND or a NOR. The M stages of circuit cells of inverters or the like are connected via interconnects as a signal path. In the design of such a logic circuit, a signal propagation delay time (hereinafter simply referred to as the delay time) caused through the propagation of a signal through the M stages of circuit cells connected as the signal path should be within a given time determined on the basis of a cycle time of a clock signal input to the logic circuit (in most cases, on the basis of a period corresponding to a reciprocal or an integral multiple of an operational frequency or a clock frequency). In other words, it is necessary to satisfy the following Formula 4:

Formula 4:
t_{cycle}≧Σtᵢ+tₒₜₕₑᵣₛ
wherein t_{cycle} indicates the upper limit of the delay time required in the design of the logic circuit; tᵢ indicates a time by which a signal input to a circuit cell disposed at an ith stage out of the M stages of the circuit cells is delayed before being output (i.e., a delay time); Σtᵢ indicates a sum of signal propagation delay times tᵢ caused in the respective circuit cells disposed between the pair of flip-flops; and tₒₜₕₑᵣₛ indicates a sum of set-up times of the pair of flip-flops, the skew of the clock signal and the like.

In general, since the design margin is set in consideration of the aforementioned delay time t_{cycle}, it is determined in consideration of coefficients P, V and T designated as derating factors, which are various delay varying factors in the form of coefficients, for delaying propagation of a signal as shown in the following Formula 5:

Formula 5:
t_{worst}=t_{typ}×P_{worst}×V_{worst}×T_{worst}
wherein t_{worst} is the worst value of the delay time Σtᵢ; t_{typ} is a standard value of the delay time Σtᵢ; P is a derating factor indicating, in the form of a coefficient, fabrication variation as the delay varying factor; V is a derating factor indicating, in the form of a coefficient, a power voltage range as the delay varying factor; and T is a derating factor indicating, in the form of a coefficient, a temperature range as the delay varying factor.

In using such derating factors, the standard value t_{typ} of the delay time Σtᵢ is first obtained, and the worst value of the delay time obtained under the worst conditions can be easily estimated as a value obtained by multiplying the standard value t_{typ} by the worst values of the respective derating factors.

In this embodiment, the circuit net list 109 stores information necessary for describing the signal path circuit 401. The circuit simulation is executed by providing the signal path circuit 401 with two kinds of fabrication variation components in the same manner as in Embodiment 1. At this point, signal propagation delay between the input and the output of the signal path circuit 401 (namely, between the input port 403 and the output port 404) is measured as a circuit characteristic. Thus, a delay distribution is obtained as the circuit simulation result 114. Herein, the obtained delay distribution is assumed to have a mean value μtpd and a standard deviation Σtpd.

Signal Path Delay Variation Evaluating Step

The signal path delay variation evaluating means 301 obtains, from the circuit simulation result 114, a value σtpd/μtpd corresponding to the signal propagation delay variation of the signal path circuit 401.

FIG. 11 is a diagram in which the signal propagation delay variation is plotted along the circuit cells 402 on the signal path circuit 401 in the case where the circuit cells 402 are connected in five stages (i.e., M=5). The signal propagation delay variation obtained by the simulation method of this embodiment is indicated by a curve L2 in FIG. 11. The intra-chip variation causes random variation among the transistors included in the signal path. Therefore, the influence of the intra-chip variation on the signal propagation delay is averaged as the signal is propagated through the circuit cells along the signal path and is reduced as a result. In this case, the value σtpd/μtpd is reduced as the signal is propagated to the later stages, and has a value BB on the output port 404. On the other hand, in the case where the extra-chip fabrication variation alone is provided as one distribution as in the conventional method, as shown with a curve L1 of FIG. 11, the value σtpd/μtdp is substantially constant (at a value AA) regardless of the stages of circuit cells. This is because one distribution is assumed to uniformly influence the whole circuit in the conventional circuit simulation. Also in the case where a signal path includes a variety of circuit cells, the trend of the two curves shown in FIG. 11 are almost the same as those shown in FIG. 11 although they are slightly different.

As shown in FIG. 11, both the two curves L1 and L2 have the value AA at the first stage of the circuit cells. The reason thereof is as follows. The signal path circuit 401 includes the plural same inverter circuit cells 402 and simple circuit cells like, for example, the circuit cells 203 or 206 as shown in FIG. 2 are assumed to be used as the inverter circuit cells 402 in the present embodiment. Accordingly, no averaging of the intra-chip variation components is caused at the first stage of the circuit cells, so that both the two curves L1 and L2 have the value AA. However, in the case where the signal path circuit includes circuit cells including a cause of averaging of the intra-chip variation components, for example, including a circuit in which transistors are connected in series, the intra-chip variation components are averaged even at the first stage of the circuit cells, with a result that the value of the curve L2 becomes smaller than the value AA at the first stage of the circuit cells.

The signal path delay variation evaluating means 301 obtains, from the value BB, the derating factor P indicating, in the form of a coefficient, the fabrication variation as the delay varying factor. The derating factor P is defined by the following Formula 6:

Formula 6:
P=t_{pd-worst}/t_{pd-typ}=(μ_{tpd}+3σ_{tpd})/μ_{tpd}=1+3BB

The signal path delay variation evaluating means 301 outputs the derating factor P thus obtained as the design margin 302 derived from the fabrication variation. On the other hand, in the conventional method, the derating factor is defined by the following Formula 7:

Formula 7:
P=1+3AA
Thus, an excessive design margin is unavoidably set in the conventional method.

In this manner, according to this embodiment, a plurality of fabrication variation components having different behaviors are respectively independently expressed so as to be selectively provided to respective components of the circuit net list, and therefore, the circuit simulation influenced by actual fabrication variation can be performed. Furthermore, a design margin can be set more realistically by using the result of the circuit simulation.

It is noted that this embodiment is merely an example of the application of the present invention, and the invention can be embodied in a variety of manners. For example, a value 3σ_{tpd} is used in Formula 6, but an arbitrary range may be used instead. Also, the method for setting a design margin using the value BB is not limited to the method using Formula 6.

Although the simple signal path circuit 401 is used in this embodiment, a critical path or the like included in an actually more complicated LSI may be selected as the signal path circuit. Also, although the design margin is determined on the basis of the evaluation of one signal path in this embodiment, the circuit simulation may be performed by the method of this embodiment on a plurality of signal paths so that the design margin can be comprehensively determined by using, for example, the largest one of the values BB obtained as a result of the circuit simulation.

Moreover, the circuit simulation may be performed by using a signal path with few stages so that the result of the circuit simulation can be extrapolated or interpolated to a signal path having an arbitrary number of stages.

### EMBODIMENT 3

A circuit simulation apparatus according to Embodiment 3 of the invention in which fabrication variation is taken into consideration will now be described with reference to the accompanying drawing. Also in this embodiment, fabrication variation of CMIS transistors will be exemplified. Furthermore, the circuit simulation apparatus of FIG. 9 is used also in this embodiment.

In this embodiment, differently from Embodiment 2, a circuit to be simulated includes a plurality of signal paths.

FIG. 12 is a block circuit diagram shown as an example of the circuit used in this embodiment. Herein, the circuit 410 includes two signal paths having one input port 411 and having two output ports 412 and 413.

It is assumed, in this embodiment, that a circuit net list 109 (see FIG. 9) corresponding to the circuit 410 is prepared for performing processing similar to that of Embodiment 2 for executing the circuit simulation. Since the circuit includes the two signal paths, two signal propagation delays, which are specifically a signal propagation delay tpd1 from the input port 411 to the output port 412 and a signal propagation delay tpd2 from the input port 411 to the output port 413, can be defined. Also, in the circuit simulation of this embodiment, a difference (skew) Δt of these delays represented by the following Formula 8 is also measured:

Formula 8:
Δt=t_{pd1}−t_{pd2}

In this embodiment, circuit simulation result 114 includes, in addition to distributions of the signal propagation delays of the two signal paths, a distribution of the delay difference Δt. A range obtained as, for example, a range 3σ of the distribution is set as the design margin.

In general, an allowable range of a delay difference such as clock skew is also set in the design margin. When the method of this embodiment is employed, the circuit simulation accurately influenced by actual fabrication variation can be performed, and hence, a source for determining a design margin for a delay difference between signal paths can be provided.

1. A circuit simulation method for performing circuit simulation for an operation of a circuit including at least one circuit element, comprising the steps of:
(a) incorporating, in accordance with a given model, variables corresponding to a plurality of fabrication variation components per parameter out of parameters included in input information stored in a memory;
(b) obtaining fabrication variation of said parameter by selectively giving fabrication variation information of respective fabrication variation components to said variables corresponding to said plurality of fabrication variation components and outputting input information influenced by said fabrication variation; and
(c) executing said circuit simulation by referring to said input information influenced by said fabrication variation of said parameter.

2. The circuit simulation method of claim 1,
wherein, in the step (b), said fabrication variation components include at least an extra-chip variation component and an intra-chip variation component, and fabrication variation information of said extra-chip variation component and fabrication variation information of said intra-chip variation component are selectively given.

3. The circuit simulation method of claim 1,
wherein, in the step (b), a plurality of random numbers are generated on the basis of said fabrication variation information of said respective fabrication variation components, and said fabrication variation of said parameter is obtained with respect to said generated random numbers by selectively giving said random numbers to said variables corresponding to said plurality of fabrication variation components for outputting said input information influenced by said fabrication variation.

4. The circuit simulation method of claim 3,
wherein a plurality of correlated random numbers are generated in the step (b).

5. The circuit simulation method of claim 1, further comprising, after the step (c), a signal path delay variation evaluating step (d) of obtaining a design margin on the basis of a result of said circuit simulation executed in the step (c).

6. The circuit simulation method of claim 5,
wherein a derating factor is used as said design margin in the step (d).

7. The circuit simulation method of claim 5,
wherein said circuit includes a plurality of signal paths, and
a signal propagation delay difference among said plurality of signal paths is obtained in the step (d).

8. A circuit simulation apparatus for performing circuit simulation for an operation of a circuit including at least one circuit element, comprising:
first means for incorporating, in accordance with a given model, variables corresponding to a plurality of fabrication variation components per parameter out of parameters included in input information;
second means for obtaining fabrication variation of said parameter by selectively giving fabrication variation information of respective fabrication variation components to said variables corresponding to said plurality of fabrication variation components by using said model used by said first means, and outputting input information influenced by said fabrication variation; and
third means for executing said circuit simulation by referring to said input information influenced by said fabrication variation of said parameter in accordance with an output of said second means.

9. The circuit simulation apparatus of claim 8,
wherein said second means includes means for generating a plurality of random numbers on the basis of said fabrication variation information of said respective fabrication variation components.

10. The circuit simulation apparatus of claim 8, further comprising fourth means for evaluating signal path delay variation in which a design margin is obtained on the basis of a result of said circuit simulation executed by said third means.
